(19) United States
(12) Patent Application Publication
(10) Pub. No.: US 2020/0269450 A1
(43) Pub. Date: Aug. 27, 2020

(54) Hair Shearing Device

(71) Applicants: William Harris, Greenville, SC (US); Jessica Harris, Greenville, SC (US)

(72) Inventors: William Harris, Greenville, SC (US); Jessica Harris, Greenville, SC (US)

(21) Appl. No.: 16/285,369

(22) Filed: Feb. 26, 2019

(51) Int. Cl. B26B 13/16; B26B 13/08

(52) U.S. Cl. CPC B26B 13/16; B26B 13/08

(57) ABSTRACT

A hair shearing device includes a pair of bars that is pivotally coupled proximate to a first end of the pair of bars so that inner faces of the bars are in substantial abutment. The pair of bars is configured to selectively pivot from an open configuration to a closed configuration. A biaser is coupled to the pair of bars proximate to the first end and is positioned for biasing the pair of bars to the open configuration. A pair of bevels is positioned singly and opposingly in the bars proximate to a second end of the pair of bars to define a cutting section and a gripping section of the pair of bars. The gripping section is configured to be grasped in a hand of a user to pivot the pair of bars to the closed configuration to sever hair that is positioned in the cutting section.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to shearing devices and more particularly pertains to a new shearing device for cutting hair.

### BRIEF SUMMARY OF THE INVENTION

An embodiment of the disclosure meets the needs presented above by generally comprising a pair of bars that is pivotally coupled proximate to a first end of the pair of bars so that inner faces of the bars are in substantial abutment. The pair of bars is configured to selectively pivot from an open configuration to a closed configuration. A biaser is coupled to the pair of bars proximate to the first end and is positioned for biasing the pair of bars to the open configuration. A pair of bevels is positioned singly and opposingly in the bars proximate to a second end of the pair of bars to define a cutting section and a gripping section of the pair of bars. The gripping section is configured to be grasped in a hand of a user to pivot the pair of bars to the closed configuration to sever hair that is positioned in the cutting section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a hair shearing device according to an embodiment of the disclosure.

FIG. 2 is a bottom view of an embodiment of the disclosure.

FIG. 3 is a side view of an embodiment of the disclosure.

FIG. 4 is a side view of an embodiment of the disclosure.

FIG. 5 is a side view of an embodiment of the disclosure.

### DETAILED DESCRIPTION OF THE INVENTION

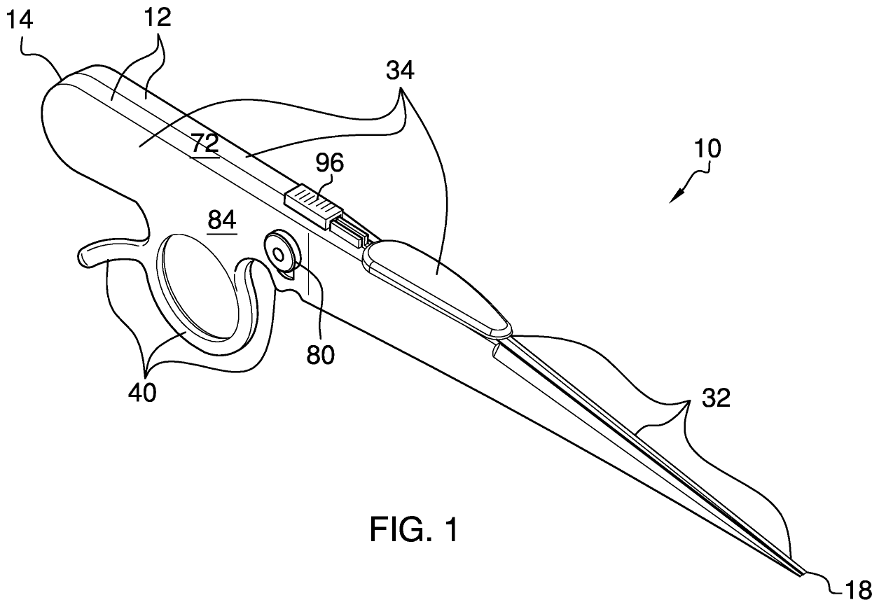

With reference now to the drawings, and in particular to FIGS. 1 through 5 thereof, a new shearing device embodying the principles and concepts of an embodiment of the disclosure and generally designated by the reference numeral 10 will be described.

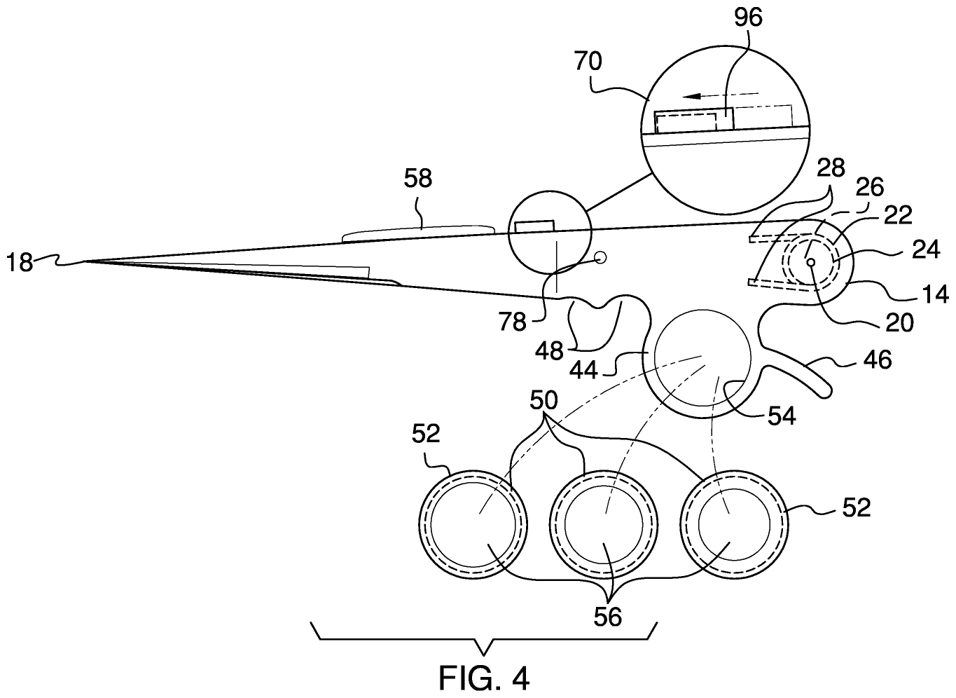

As best illustrated in FIGS. 1 through 5, the hair shearing device 10 generally comprises a pair of bars 12 that is mutually pivotally coupled proximate to a first end 14 of the pair of bars 12 so that inner faces 94 of the bars 12 are in substantial abutment. The pair of bars 12 is configured to be selectively pivoted from an open configuration, as shown in FIG. 3, to a closed configuration, as shown in FIG. 4. The first end 14 is arcuate. The pair of bars 12 has a lower surface 16 that is tapered proximate to a second end 18 of the pair of bars 12 so that the second end 18 is pointed.

A pin 20 is coupled to and extends between the pair of bars 12 proximate to the first end 14. The pin 20 is rotationally coupled to at least one of the bars 12 so that the bars 12 are pivotally coupled.

A biaser 22 is coupled to the pair of bars 12 proximate to the first end 14. The biaser 22 is positioned to bias the pair of bars 12 to the open configuration. The biaser 22 comprises a spring 24, which is coil type and positioned around the pin 20 in a recess 26 that is positioned in the pair of bars 12, as shown in FIG. 4. The spring 24 has opposing ends 28, each of which is coupled to an associated bar 12. The spring 24 is positioned to bias the pair of bars 12 to the open configuration.

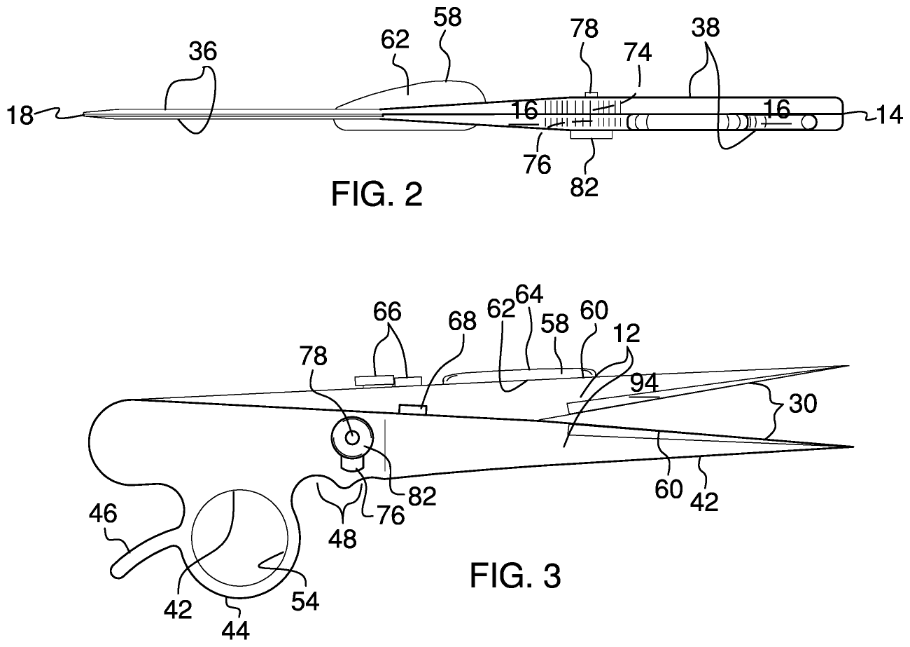

A pair of bevels 30 is positioned singly and opposingly in the bars 12 proximate to the second end 18 of the pair of bars 12, as shown in FIG. 3, to define a cutting section 32 and a gripping section 34 of the pair of bars 12. The gripping section 34 is configured to be grasped in a hand of a user to pivot the pair of bars 12 to the closed configuration to sever hair that is positioned in the cutting section 32. The cutting section 32 has opposing faces 36 and the gripping section 34 has opposing sides 38. The opposing sides 38 have a greater separation than the opposing faces 36 so that the gripping section 34 is dimensionally thicker than the cutting section 32, as shown in FIG. 2. Each opposing side 38 tapers to an associated opposing face 36, as shown in FIG. 2.

A grip 40 is coupled to and extends from a lower edge 42 of one of the pair of bars 12 proximate to the first end 14 of the pair of bars 12, as shown in FIG. 3. The grip 40 is configured to position fingers of the hand of the user. The grip 40 comprises a ring 44, an arm 46, and a pair of indentations 48. The ring 44 is coupled to and extends substantially coplanarly from the lower edge 42 of the one of the pair of bars 12. The ring 44 is configured to insert a fourth digit of the hand of the user. The arm 46 is coupled to and extends from the ring 44 toward the first end 14 of the pair of bars 12 and is configured to contact a fifth digit of the hand of the user. The pair of indentations 48 is positioned in the lower edge 42 of the one of the bars 12, opposingly to the arm 46. The pair of indentations 48 is configured to insert a first digit and a second digit of the hand of the user.

The device 10 also comprises a plurality of discs 50, as shown in FIG. 4. The discs 50 comprises at least one of rubber and silicone so that the discs 50 are resiliently compressible. Each disc 50 has an outer circumference 52 that is complementary to an inner perimeter 54 of the ring 44. The user is positioned to insert the disc 50 into the ring 44 to frictionally couple the disc 50 to the ring 44.

Each of a plurality of apertures 56 is positioned in a respective disc 50. Each aperture 56 has a respective size so that the plurality of discs 50 comprises discs 50 that have apertures 56 of a variety of sizes. A user is positioned to insert a respective disc 50 that has an aperture 56 that is sized complementarily to the fourth digit of the hand of the user into the ring 44 so that the disc 50 is configured to pad the ring 44.

A pad 58 is coupled to an upper edge 60 of the other of the bars 12, as shown in FIG. 1. The pad 58 is positioned on the gripping section 34 proximate to the cutting section 32. The pad 58 is configured to position a first digit of the hand of the user, positioning the user to tighten a grasp of the hand on the gripping section 34 to pivot the pair of bars 12 to the closed configuration to sever the hair that is positioned in the cutting section 32. The pad 58 has a lower limit 62 and an upper limit 64. The lower limit 62 extends bidirectionally past the opposing sides 38 of the gripping section 34. The upper limit 64 is arcuate. The pad 58 comprises at least one of rubber and silicone so that the pad 58 is resiliently compressible.

A first coupler 66 is coupled to one of the pair of bars 12. A second coupler 68 is coupled to the other of the pair of bars 12. The second coupler 68 is complementary to the first coupler 66. The second coupler 68 is positioned to selectively couple to the first coupler 66, when the pair of bars 12 is in the closed configuration, to fixedly position the pair of bars 12 in the closed configuration. The second coupler 68 and the first coupler 66 comprise a slide lock 70 that is coupled to an upper surface 72 of the pair of bars 12, as shown in FIG. 4.

A hole 74 is positioned in one of the pair of bars 12, as shown in FIG. 4. The hole 74 is internally threaded. A slot 76 positioned in the other of the pair of bars 12 and is aligned with the hole 74. A shaft 78 of a thumbscrew 80 extends through the slot 76 and is threadedly inserted through the hole 74 so that a knob 82 of the thumbscrew 80 is positioned adjacent to an outer face 84 of the other of the bars 12, as shown in FIG. 3. The thumbscrew 80 is configured to be selectively rotated to adjust a tension between the pair of bars 12.

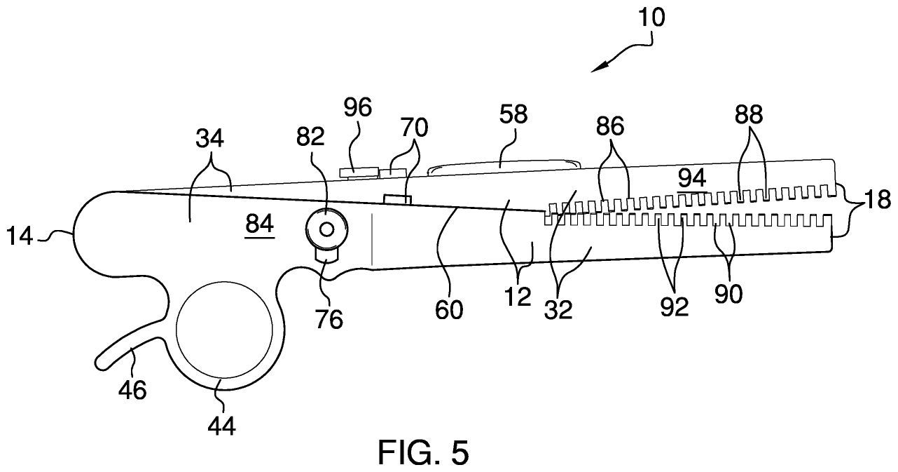

In another embodiment, as shown in FIG. 5, a plurality of first notches 86 is positioned in one of the pair of bevels 30 to define a set of first teeth 88. A plurality of second notches 90 is positioned in the other of the pair of bevels 30 to define a set of second teeth 92. The pair of bevels 30 is configured to intermittently sever the hair that is positioned in the cutting section 32. Each second tooth 92 is aligned with an associated first notch 86. In this embodiment, the second end 18 is blunted.

In use, the gripping section 34 is grasped in the hand of the user with the first digit positioned on the pad 58 and the fingers positioned respectively on the arm 46, in the ring 44, and in the pair of indentations 48. The user then uses the first digit to motivate a slider 96 of the slide lock 70 toward the first end 14 to unlock the pair of bars 12 wherein the spring 24 urges the pair of bars 12 to the open configuration. The hair is then positioned in the cutting section 32, between the pair of bars 12, positioning the user to tighten the grasp of the hand to pivot the pair of bars 12 to the closed configuration to sever the hair.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hair shearing device comprising:
a pair of bars, the bars being mutually pivotally coupled proximate to a first end of the pair of bars such that inner faces of the bars are in substantial abutment wherein the pair of bars is configured for selectively pivoting from an open configuration to a closed configuration;
a biaser coupled to the pair of bars proximate to the first end wherein the biaser is positioned for biasing the pair of bars to the open configuration;
a pair of bevels positioned singly and opposingly in the bars proximate to a second end of the pair of bars defining a cutting section and a gripping section of the pair of bars wherein the gripping section is configured for grasping in a hand of a user for pivoting the pair of bars to the closed configuration for severing hair positioned in the cutting section;
a first coupler coupled to one of the pair of bars; and
a second coupler coupled to the other of the pair of bars, the second coupler being complementary to the first coupler wherein the second coupler is positioned for selectively coupling to the first coupler when the pair of bars is in the closed configuration for fixedly positioning the pair of bars in the closed configuration, the second coupler and the first coupler comprising a slide lock coupled to an upper surface of the pair of bars.

2. The device of claim 1, further including the first end being arcuate.

3. The device of claim 1, further including the pair of bars having a lower surface, the lower surface being tapered proximate to the second end of the pair of bars such that the second end is pointed.

4. The device of claim 1, further comprising:
a pin coupled to and extending between the pair of bars proximate to the first end, the pin being rotationally coupled to at least one of the bars such that the bars are pivotally coupled; and
the biaser comprising a spring positioned around the pin in a recess positioned in the pair of bars, the spring having opposing ends, each opposing end being coupled to its associated bar wherein the spring is positioned for biasing the pair of bars to the open configuration.

5. The device of claim 4, further including the spring being coil type.

6. The device of claim 1, further including the cutting section having opposing faces and the gripping section having opposing sides, the opposing sides having a greater separation than the opposing faces such that the gripping section is dimensionally thicker than the cutting section.

7. The device of claim 6, further including each opposing side tapering to an associated opposing face.

8. The device of claim 1, further comprising:
a grip coupled to and extending from a lower edge of one of the pair of bars proximate to the first end of the pair of bars wherein the grip is configured for positioning fingers of the hand of the user; and
a pad coupled to an upper edge of the other of the bars, the pad being positioned on the gripping section proximate to the cutting section wherein the pad is configured for positioning a first digit of the hand of the user positioning the user for tightening a grasp of the hand on the gripping section for pivoting the pair of bars to the closed configuration for severing the hair positioned in the cutting section.

9. The device of claim 8, further including the grip comprising:
a ring coupled to and extending substantially coplanarly from the lower edge of the one of the pair of bars wherein the ring is configured for inserting a fourth digit of the hand of the user;
an arm coupled to and extending from the ring toward the first end of the pair of bars wherein the arm is configured for contacting a fifth digit of the hand of the user; and
a pair of indentations positioned in the lower edge of the one of the bars, the indentations being positioned opposingly to the arm wherein the pair of indentations is configured for receiving a second digit and a third digit of the hand of the user.

10. The device of claim 9, further comprising:
a plurality of discs, the discs comprising at least one of rubber and silicone such that the discs are resiliently compressible, each disc having an outer circumference, the outer circumference being complementary to an inner perimeter of the ring wherein the user is positioned for inserting the disc into the ring for frictionally coupling the disc to the ring; and
a plurality of apertures, each aperture being positioned in a respective disc, each aperture having a respective size such that the plurality of discs comprises discs having apertures of a variety of sizes such that the user is positioned for inserting a respective disc having an aperture sized complementarily to the fourth digit of the hand of the user into the ring wherein the disc is configured for padding the ring.

11. The device of claim 8, further including the pad having a lower limit and an upper limit, the lower limit extending bidirectionally past opposing sides of the gripping section, the upper limit being arcuate.

12. The device of claim 8, further including the pad comprising at least one of rubber and silicone such that the pad is resiliently compressible.

13. (canceled)

14. (canceled)

15. The device of claim 1, further comprising:
a hole positioned in one of the pair of bars, the hole being internally threaded;
a slot positioned in the other of the pair of bars, the slot being aligned with the hole; and
a thumbscrew having a shaft extending through the slot and threadedly inserted through the hole such that a knob of the thumbscrew is positioned adjacent to an outer face of the other of the bars wherein the thumbscrew is configured for being selectively rotated for adjusting a tension between the pair of bars.

16. The device of claim 1, further including a plurality of first notches positioned in one of the pair of bevels defining a set of first teeth wherein the one of the pair of bevels is configured for intermittently severing the hair of positioned in the cutting section.

17. The device of claim 16, further including a plurality of second notches positioned in the other of the pair of bevels defining a set of second teeth wherein the other of the pair of bevels is configured for intermittently severing the hair positioned in the cutting section.

18. The device of claim 17, further comprising:
the second end being blunted; and
each of the second teeth being aligned with an associated one of the plurality of first notches.

19. A hair shearing device comprising:
a pair of bars, the bars being mutually pivotally coupled proximate to a first end of the pair of bars such that inner faces of the bars are in substantial abutment wherein the pair of bars is configured for selectively pivoting from an open configuration to a closed configuration, the first end being arcuate, the pair of bars having a lower surface, the lower surface being tapered proximate to a second end of the pair of bars such that the second end is pointed;
a pin coupled to and extending between the pair of bars proximate to the first end, the pin being rotationally coupled to at least one of the bars such that the bars are pivotally coupled;
a biaser coupled to the pair of bars proximate to the first end wherein the biaser is positioned for biasing the pair of bars to the open configuration, the biaser comprising a spring positioned around the pin in a recess positioned in the pair of bars, the spring having opposing ends, each opposing end being coupled to its associated bar wherein the spring is positioned for biasing the pair of bars to the open configuration, the spring being coil type;
a pair of bevels positioned singly and opposingly in the bars proximate to the second end of the pair of bars defining a cutting section and a gripping section of the pair of bars wherein the gripping section is configured for grasping in a hand of a user for pivoting the pair of bars to the closed configuration for severing hair positioned in the cutting section, the cutting section having opposing faces and the gripping section having opposing sides, the opposing sides having a greater separation than the opposing faces such that the gripping section is dimensionally thicker than the cutting section, each opposing side tapering to an associated opposing face;
a grip coupled to and extending from a lower edge of one of the pair of bars proximate to the first end of the pair of bars wherein the grip is configured for positioning fingers of the hand of the user, the grip comprising:
a ring coupled to and extending substantially coplanarly from the lower edge of the one of the pair of bars wherein the ring is configured for inserting a fourth digit of the hand of the user,
an arm coupled to and extending from the ring toward the first end of the pair of bars wherein the arm is configured for contacting a fifth digit of the hand of the user, and
a pair of indentations positioned in the lower edge of the one of the bars, the indentations being positioned opposingly to the arm wherein the pair of indentations is configured for receiving a second digit and a third digit of the hand of the user;
a plurality of discs, the discs comprising at least one of rubber and silicone such that the discs are resiliently compressible, each disc having an outer circumference, the outer circumference being complementary to an inner perimeter of the ring wherein the user is positioned for inserting the disc into the ring for frictionally coupling the disc to the ring;
a plurality of apertures, each aperture being positioned in a respective disc, each aperture having a respective size such that the plurality of discs comprises discs having apertures of a variety of sizes such that the user is positioned for inserting a respective disc having an aperture sized complementarily to the fourth digit of the hand of the user into the ring wherein the disc is configured for padding the ring;
a pad coupled to an upper edge of the other of the bars, the pad being positioned on the gripping section proximate to the cutting section wherein the pad is configured for positioning a first digit of the hand of the user positioning the user for tightening a grasp of the hand on the gripping section for pivoting the pair of bars to the closed configuration for severing the hair positioned in the cutting section, the pad having a lower limit and an upper limit, the lower limit extending bidirectionally past opposing sides of the gripping section, the upper limit being arcuate, the pad comprising at least one of rubber and silicone such that the pad is resiliently compressible;
a first coupler coupled to one of the pair of bars;
a second coupler coupled to the other of the pair of bars, the second coupler being complementary to the first coupler wherein the second coupler is positioned for selectively coupling to the first coupler when the pair of bars is in the closed configuration for fixedly positioning the pair of bars in the closed configuration, the second coupler and the first coupler comprising a slide lock coupled to an upper surface of the pair of bars;
a hole positioned in one of the pair of bars, the hole being internally threaded;
a slot positioned in the other of the pair of bars, the slot being aligned with the hole; and
a thumbscrew having a shaft extending through the slot and threadedly inserted through the hole such that a knob of the thumbscrew is positioned adjacent to an outer face of the other of the bars wherein the thumbscrew is configured for being selectively rotated for adjusting a tension between the pair of bars.

20. The device of claim 19, further comprising:
a plurality of first notches positioned in one of the pair of bevels defining a set of first teeth wherein the one of the pair of bevels is configured for intermittently severing the hair positioned in the cutting section; and
a plurality of second notches positioned in the other of the pair of bevels defining a set of second teeth wherein the pair of bevels is configured for intermittently severing the hair positioned in the cutting section, each of the second teeth being aligned with an associated one of the plurality of first notches.
